(19) United States
(12) Patent Application Publication
(10) Pub. No.: US 2009/0308196 A1
(43) Pub. Date: Dec. 17, 2009

(54) CYCLE PEDAL

(76) Inventor: Oz Cabiri, Macabim (IL)

Correspondence Address: David Klein;DEKEL PATENT LTD., Beit HaRof'im, 18 Menuha VeNahala Street, Room 27, REHOVOT, IL

(21) Appl. No.: 12/480,887

(22) Filed: Jun. 9, 2009

Related U.S. Application Data
(60) Provisional application No. 61/060,482, filed on Jun. 11, 2008.

(51) Int. Cl. B62M 3/00

(52) U.S. Cl. 74/594.4

(57) ABSTRACT

A cycle pedal including a pedal frame rotatably mounted on a rotation axis of a pedal pin, the pedal pin being securable to a crank arm of a cycle, a clamping mechanism for securing a rider's foot to the cycle pedal, and a ratchet mechanism coupled to the rotation axis and operative to permit rotation of the pedal frame about the rotation axis only in a first direction, wherein in a second direction opposite to the first direction, the ratchet mechanism does not permit rotation of the pedal frame about the rotation axis and is operative together with the clamping mechanism to transmit torque power in the second direction to the crank arm, wherein the ratchet mechanism comprises a toothed cog that ratchets with a pawl, and wherein the toothed cog has ratchet teeth only on a portion thereof.

### CROSS-REFERENCE TO RELATED APPLICATIONS

This application claims priority under 35 USC §119 to U.S. Provisional Patent Application 61/060,482, filed Jun. 11, 2008, which is incorporated herein by reference.

### FIELD OF THE INVENTION

The present invention relates generally to bicycles, and particularly to a bicycle pedal (or tricycle pedal) that is ratcheted for improved power transmission throughout the pedal cycle.

### BACKGROUND OF THE INVENTION

One of the known problems in cycling is transmitting power (that is, moment or torque) as the crank arms rotate at or near bottom dead center and top dead center. The use of toe clips helps but only to a limited extent by applying a force parallel to the pedal movement at the dead centers.

### SUMMARY OF THE INVENTION

The present invention seeks to provide a cycle pedal (for a bicycle, tricycle or the like) that is ratcheted for improved power transmission throughout the pedal cycle, as is described more in detail hereinbelow. The system of the invention is a “direct moment creator” because it creates a direct moment (torque) via the pedal itself during rotation of the crank arm independent of the crank arm position.

There is thus provided in accordance with an embodiment of the present invention a cycle pedal including a pedal frame rotatably mounted on a rotation axis of a pedal pin, the pedal pin being securable to a crank arm of a cycle, a clamping mechanism for securing a rider's foot to the cycle pedal, and a ratchet mechanism coupled to the rotation axis and operative to permit rotation of the pedal frame about the rotation axis only in a first direction, wherein in a second direction opposite to the first direction, the ratchet mechanism does not permit rotation of the pedal frame about the rotation axis and is operative together with the clamping mechanism to transmit power in the second direction to the crank arm.

The ratchet mechanism may be mounted between the pedal pin and the crank arm. The ratchet mechanism may include, for example, a toothed cog that ratchets with a pawl, the pawl being connected to the crank arm so as to transmit power thereto when the pedal frame moves in the second direction.

When a cyclist pedals with the pedal of the present invention and reaches bottom dead center, the ratchet mechanism together with the clamping mechanism applies power to the crank arm as the rotary motion of the pedal moves from bottom dead center radially upwards about the center of rotation. Furthermore, the present invention provides the rider the possibility of activating movement of the rider's foot at the top down and top up positions. At these positions, forcing the leg down or up will not create any additional moment, the forces being isotonic (activating the muscles without creating external work). However, rotating the foot itself against the ratchet mechanism while the foot is locked to the pedal (with toe clips, clamps or other mechanism), creates a moment (torque) that is directly transferred to the crank arm, chain and wheels.

In accordance with an embodiment of the present invention, the ratchet mechanism is selectively coupled to the clamping mechanism such that clamping a rider's foot to the clamping mechanism couples the ratchet mechanism to the rotation axis to permit rotation of the pedal frame about the rotation axis only in the first direction, and disengaging the rider's foot from the clamping mechanism releases the ratchet mechanism from the rotation axis to permit the pedal frame to rotate freely about the rotation axis and enable easier connection of the shoe to the pedal.

In accordance with another embodiment of the present invention, the pawl is selectively coupled to a locker of the clamping mechanism, such that clamping a rider's foot to the clamping mechanism with the locker moves the pawl into ratchet engagement with the toothed cog, and disengaging the rider's foot from the clamping mechanism releases the pawl from ratchet engagement with the toothed cog.

### BRIEF DESCRIPTION OF THE DRAWINGS

The present invention will be understood and appreciated more fully from the following detailed description taken in conjunction with the drawings in which:

FIGS. 1 and 2 are simplified pictorial and sectional illustrations, respectively, of a pedal, constructed and operative in accordance with an embodiment of the present invention;

FIG. 3 is a simplified pictorial illustration of the pedal of FIGS. 1 and 2 together with a clamping mechanism, in accordance with an embodiment of the present invention;

FIGS. 4 and 5 are a simplified flow chart and a simplified pictorial illustration, respectively, of another embodiment of the ratchet mechanism of the present invention, wherein the ratchet mechanism is linked to the clamping mechanism; and

FIGS. 6A-6E are simplified pictorial illustrations of the pedal of FIG. 1, with a modified ratchet mechanism that has ratchet teeth only a portion of a toothed cog, constructed and operative in accordance with an embodiment of the present invention.

### DETAILED DESCRIPTION OF EMBODIMENTS

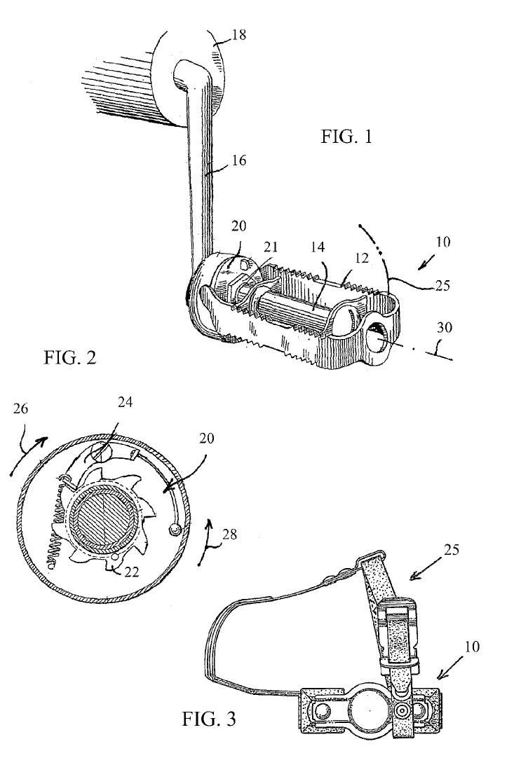

Reference is now made to FIGS. 1 and 2, which illustrate a cycle pedal 10, constructed and operative in accordance with an embodiment of the present invention.

Pedal 10 may include a pedal frame 12 rotatably mounted on a pedal pin 14, which is secured in known (left-handed) threaded fashion to a crank 16 of a cycle 18, such as a bicycle or tricycle or other manual pedal-operated machine. Pedal pin 14 has a rotation axis 30 (longitudinal axis).

A ratchet mechanism 20 is mounted between the pedal pin 14 and the crank 16 (secured, for example, by a nut 21). The ratchet mechanism 20 may include a toothed cog 22 that ratchets with a pawl 24 and transmits power in the direction indicated by arrow 26 to crank 16. This is the direction that the ratchet mechanism 20 does not permit rotation of pedal frame 12 about rotation axis 30. The pawl 24 is connected to the crank 16 so as to transmit power thereto. In the opposite direction, indicated by arrow 28, no power is transmitted to crank 16 by the ratchet mechanism 20 and the pedal 10 acts to move the crank 16 like a regular, non-ratcheted pedal. This is the direction that the ratchet mechanism 20 does permit rotation of pedal frame 12 about rotation axis 30.

It is noted that this is merely one non-limiting example of a ratchet mechanism that may be used to carry out the invention and many other ratchet mechanisms may be used, such as but not limited to, ratchet balls, conic lock ratchets and others.

It is noted that Japanese Patent Document JP1182186 describes a ratchet mechanism in a pedal, but it is different from the present invention. In JP1182186, a ratchet is mounted to the neck part of a pedal shaft having a wide pedal. The ratchet becomes engaged only during stepping downwards the pedal. By stepping on the tip part of the wide pedal, the length of a pedaling force exerting point is increased. JP1182186 does not contemplate creating a moment on the upswing of the pedal rotation (from bottom dead center upwards).

The present invention is most effective when used together with a clamping mechanism 25 (seen in FIG. 3, and also shown in broken lines in FIG. 1 so as not to obscure the other elements). The term “clamping mechanism” encompasses toe clips, clamps, shoes and the like for securing the rider's foot to the pedal. When a cyclist pedals with the pedal 10 of the present invention and reaches bottom dead center, the ratchet mechanism 20 together with clamping mechanism 25 applies power to the crank arm as the rotary motion of the pedal moves from bottom dead center radially upwards about the center of rotation (rotation axis 30 of pedal pin 14). In the present invention, the pedal speed is substantially constant throughout the pedal rotation and the extra torque power comes from the ratchet mechanism.

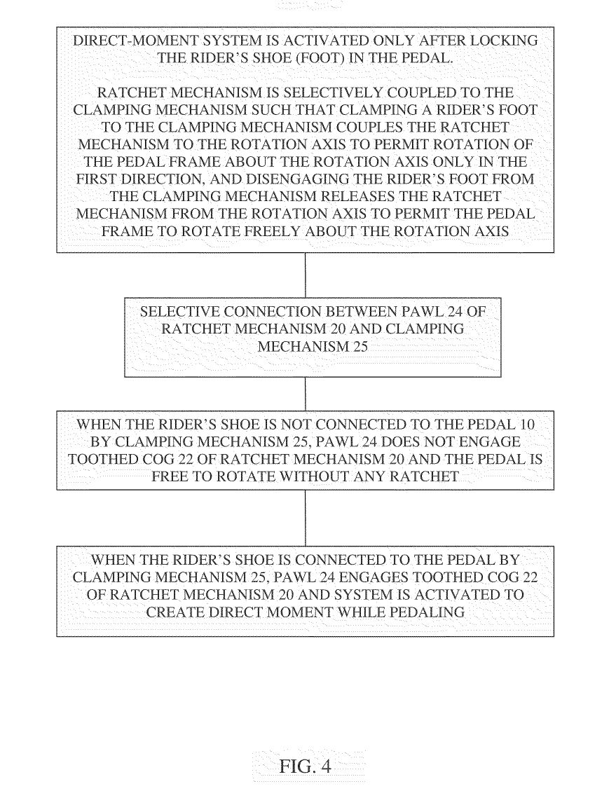

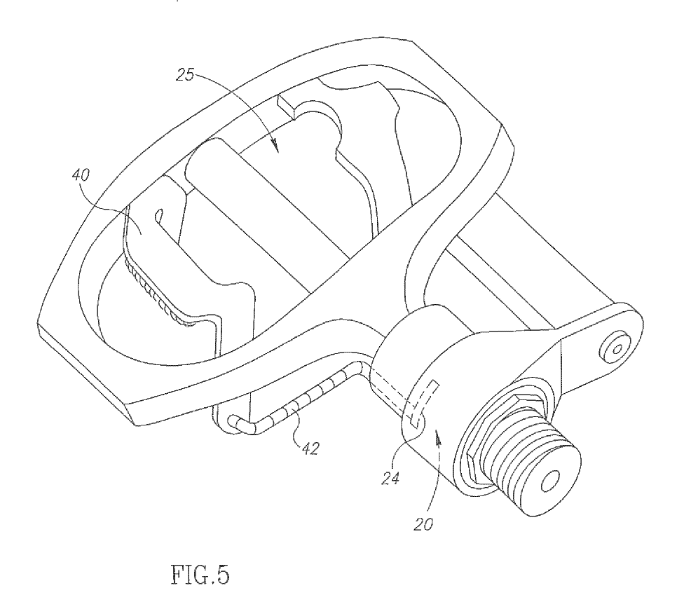

Reference is now made to FIG. 4, which schematically illustrates in flow chart form another embodiment of the ratchet mechanism. In the above-described embodiments, the ratchet mechanism of the pedal may interfere with the angular freedom of the pedal when the rider clamps the clamping mechanism. In the embodiment of FIG. 4, the direct-moment system of the invention is activated only after locking the rider's shoe (foot) in the pedal. Referring additionally to FIG. 5, this is accomplished by selectively connecting between the lock pin (i.e., pawl 24) of ratchet mechanism 20 and a locker 40 (e.g., cleat locker) of clamping mechanism 25, such as by means of a link 42 between locker 40 and pawl 24. When the rider's shoe is not connected to the pedal 10 by clamping mechanism 25, pawl 24 does not engage toothed cog 22 of ratchet mechanism 20 and the pedal is free to rotate without any ratchet. This enables easy adjustment between the foot and shoe with the clamping mechanism during engagement. When the rider's shoe is connected to the pedal by clamping mechanism 25, pawl 24 engages the toothed cog 22 of ratchet mechanism 20 and the system of the invention is now activated to create direct moment while pedaling.

The embodiment of FIG. 4 can be used with any kind of locker and clamping mechanism. Non-limiting examples include toeclips or toestraps (where the locker is, for example, a strap), and clipless pedals (e.g., clip-in or step-in) that use a cycling shoe with a cleat fitted to the sole, which locks into a mechanism in the pedal holding the shoe firmly to the pedal. An example of a quick-release clipless pedal is the well-known SPD (Shimano Pedaling Dynamics), wherein the cleat is engaged by pushing down and forward on the pedal, or by twisting the cleat sideways. Instead of loosening a toestrap or pulling a lever, the rider releases his/her foot from the pedal by twisting the heel outwards. In the embodiment of FIG. 4, engaging the cleat on the pedal activates ratchet mechanism 20 and disengaging the cleat from the pedal releases ratchet mechanism 20.

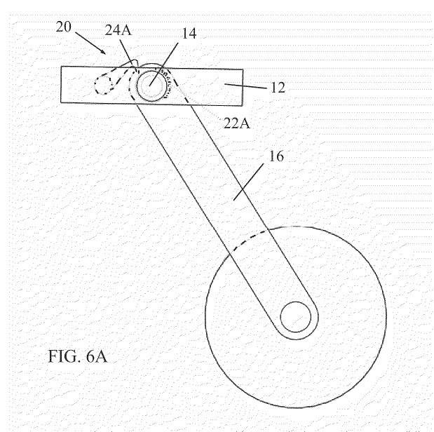

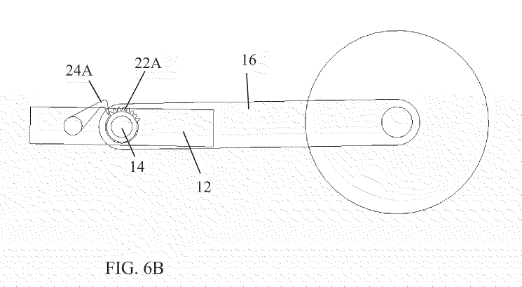

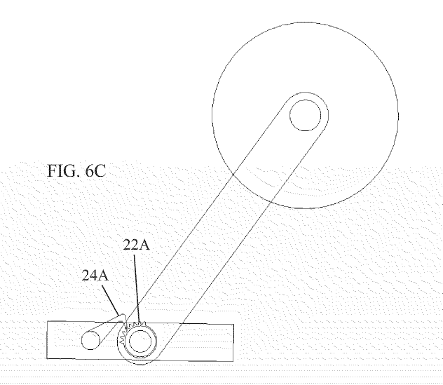

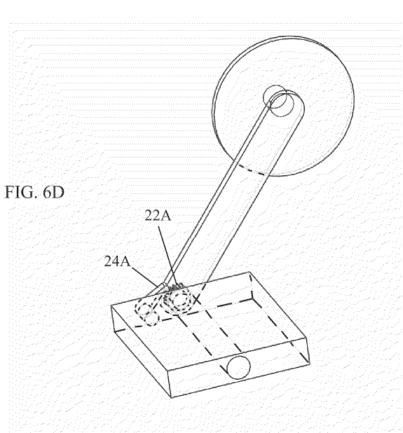

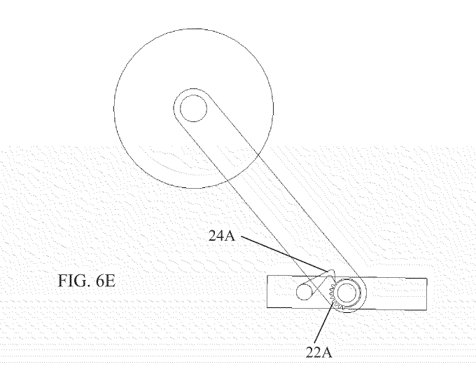

Reference is now made to FIGS. 6A-6E, which illustrate the pedal of FIG. 1, with a modified ratchet mechanism. As described above, ratchet mechanism 20 is mounted between the pedal frame 12 and the pin 14 that is connected to crank 16. In this ratchet mechanism, toothed cog 22A has ratchet teeth only on a portion thereof (not fully around the circumference) that ratchets with a pawl 24A. The rest of toothed cog 22A does not have ratchet teeth. This construction with angular freedom at portions of the rotation where the ratchet is less useful may be simpler to construct and easier for the cyclist to use. This construction may be used in combination with any of the above described embodiments.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. An article comprising:
a cycle pedal comprising a pedal frame rotatably mounted on a rotation axis of a pedal pin, said pedal pin being secured to a crank arm of a cycle;
a clamping mechanism for securing a rider's foot to the cycle pedal; and
a ratchet mechanism coupled to said rotation axis and operative to permit rotation of said pedal frame about said rotation axis only in a first direction, wherein in a second direction opposite to the first direction, said ratchet mechanism does not permit rotation of said pedal frame about said rotation axis and is operative together with said clamping mechanism to transmit power in the second direction to the crank;
wherein said ratchet mechanism comprises a toothed cog that ratchets with a pawl, said pawl being connected to said crank arm so as to transmit power thereto when said pedal frame moves in said second direction, and wherein said toothed cog has ratchet teeth only on a portion thereof, not fully around a circumference of said toothed cog.

2. The article according to claim 1, wherein said ratchet mechanism is selectively coupled to said clamping mechanism such that clamping a rider's foot to said clamping mechanism couples said ratchet mechanism to said rotation axis to permit rotation of said pedal frame about said rotation axis only in the first direction, and disengaging the rider's foot from said clamping mechanism releases said ratchet mechanism from said rotation axis to permit said pedal frame to rotate freely about said rotation axis.

3. The article according to claim 1, wherein said pawl is selectively coupled to said clamping mechanism, such that clamping a rider's foot to said clamping mechanism with said clamping mechanism moves said pawl into ratchet engagement with said toothed cog, and disengaging the rider's foot from said clamping mechanism releases said pawl from ratchet engagement with said toothed cog.

4. A method comprising:
providing a cycle pedal comprising a pedal frame rotatably mounted on a rotation axis of a pedal pin, said pedal pin being securable to a crank arm of a cycle, and a ratchet mechanism coupled to said rotation axis and operative to permit rotation of said pedal frame about said rotation axis only in a first direction, wherein in a second direction opposite to the first direction, said ratchet mechanism does not permit rotation of said pedal frame about said rotation axis and is operative to transmit power in the second direction to the crank arm, wherein said ratchet mechanism comprises a toothed cog that ratchets with a pawl, said pawl being connected to said crank arm so as to transmit power thereto when said pedal frame moves in said second direction, and wherein said toothed cog has ratchet teeth only on a portion thereof, not fully around a circumference of said toothed cog;
securing a rider's foot to the cycle with a clamping mechanism; and
pedaling said cycle pedal, wherein as the rotary motion of the pedal moves from bottom dead center radially upwards about said rotation axis, said ratchet mechanism together with said clamping mechanism applies power to said crank arm.

5. The method according to claim 4, further comprising creating a moment with the ratchet mechanism as the rider's foot moves at top down and top up positions.

6. The method according to claim 4, wherein pedal speed is substantially constant throughout pedal rotation and extra power comes from said ratchet mechanism.

7. The method according to claim 4, further comprising selectively coupling said ratchet mechanism to said clamping mechanism such that clamping a rider's foot to said clamping mechanism couples said ratchet mechanism to said rotation axis to permit rotation of said pedal frame about said rotation axis only in the first direction, and disengaging the rider's foot from said clamping mechanism releases said ratchet mechanism from said rotation axis to permit said pedal frame to rotate freely about said rotation axis.
